(19) United States
(12) Patent Application Publication
(10) Pub. No.: US 2014/0062088 A1
(43) Pub. Date: Mar. 6, 2014

(54) Hydraulic tidal and wind turbines with hydraulic accumulator

(71) Applicant: Fred K. Carr, Chapel Hill, NC (US)

(72) Inventor: Fred K. Carr, Chapel Hill, NC (US)

(21) Appl. No.: 13/573,223

(22) Filed: Sep. 4, 2012

(51) Int. Cl. F03B 13/00; F03B 13/26; F03D 9/00

(52) U.S. Cl. 290/53; 290/54; 290/55

(57) ABSTRACT

Tidal and wind turbines utilize a hydraulic drive-train to transfer the kinetic energy in moving currents to a generator located ground level for producing electricity for the grid. A rotor shaft transfers the mechanical energy from the rotors to a hydraulic pump which converts the mechanical energy into fluid energy which is transferred to a high pressure manifold and then to hydraulic motor for converting the fluid energy into rotational mechanical energy which spins a generator coupled to the motor. A high pressure manifold is coupled to a hydraulic accumulator for storing the fluid energy for later use.

### BACKGROUND OF THE INVENTION

1. Field of the Invention

The present invention relates to an electrical generation system which includes tidal and wind turbines having hydraulic drive-trains which include a low-speed hydraulic pump driven at rotor speed by the kinetic energy in the water or wind currents pumping fluid into a high-pressure manifold coupled to a large hydraulic accumulator for storing energy where the pressurized fluid drives a hydraulic motor coupled to a generator for generating electricity.

2. Description of the Prior Art

There has been a recent surge of interest in using renewable fuel sources to generate electricity. The public is concerned with pollution and the eventual depletion of carbon based fuels, and the utility companies are concerned with Renewable Energy Mandates which require that a certain percentage of their retail electricity come from renewable energy sources. In the US, state and federal mandates require approximately 10 percent of the residential electricity sold by a utility come from a renewable source, other countries have similar requirements and goals. These mandates have created a sub-market in the electricity markets as the utilities most often purchase this electricity from non-utility merchant generators. While the US presently has mandates requiring approximately 10 percent of the residential electricity come from renewable energy fuels, it has generating capacity for only about 5 percent renewable suggesting a good market for electricity from renewable sources.

In the present disclosure, water turbines and wind turbines are used in combination at the same generating site wherein the water turbines use the kinetic energy in the flowing water to turn the rotors and the wind turbines use the kinetic energy in the moving air to turn the rotors. Both type systems use a hydrostatic drive-train which includes a high-pressure manifold coupled to a hydraulic accumulator providing a method to store fluid energy for later use. The stored fluid energy can be used to respond quickly to temporary demands.

The power density, and the amount of electricity, generated by the moving current (wind or water) by a turbine is directly proportional to the rotor swept area, the density of the fluid, the cube of the current speed, and the efficiencies of the generating system's rotors, transmission, generator, and power conditioner. Since the power density formula is proportional to the cube of the current speed, speed is the major factor.

Tidal currents are created by the rise and fall of sea level caused by the combined effects of the gravitational forces exerted by the moon and sun, and the rotation of the earth. On most shorelines there are two almost equal high tides and two low tides each day called a semi-diurnal tide, other locations experience diurnal tides. Tides produce oscillating currents known as tidal streams from which tidal turbines harness the kinetic energy to generate electricity. When the tides reverse direction, there is a moment of zero flow called slack water or tide.

Since tidal currents are caused by gravity, they are exactly predictable for centuries in advance. Tidal charts list times for current levels and peak speeds for several years in advance for thousands of locations throughout the world. United States patent document US2012-0114483 having the same inventor discloses and claims a microprocessor control center (MPCC) for using programmed tidal charts to control rotor direction and pitch in water turbines according to the tides. The MPCC changes the rotor direction at slack water, and thereafter adjusts the rotor pitch during the tidal cycle according to the tidal charts to maximize energy extraction. The 0114483 disclosure is incorporated as a disclosure reference. Typically in a semi-diurnal current there are four nearly equal cycles per day lasting just over 6 hours each. Since there is zero flow at slack water, the power density is low just before and following slack water.

The tidal charts make it possible to predict almost exactly the time and amount of power being produced from a water turbine. On the other hand winds are intermittent, thus the time and amount of electrical production from a wind turbine is unpredictable. Since the use of electricity varies according to time each day, utilities use preplanned daily production schedules to equate supply to demand. Unpredictability of production from wind turbines can have a negative effect on production schedules. Also, the grid can tolerate only a limited amount of unscheduled electricity input since supply must meet minute by minute demand.

Water and wind currents turn rotors at relatively low speeds which can range up to about 150 RPM. Synchronous generators, on the other hand, need to spin around 1500-1800 RPM to generate 60 cycle AC electricity for the grid. Most wind and water turbines presently use mechanical step-up gears to increase the rotational speed from the rotor to the generator. Operating history has shown these mechanical gears to be a major problem in the wind industry. The present disclosure uses a hydraulic drive-train to replace the mechanical step-up gears presently used. The hydrostatic drive-trains allow the rotors and generator to be distantly located from each other as well as other advantages latter discussed.

The hydraulic drive-train is formed from a low-speed hydraulic pump which is driven at rotor speed by the kinetic energy fuel source through a rotor shaft. The hydraulic pump generates pressurized hydraulic fluid which is pumped to a high-pressure manifold which may be coupled to a hydraulic accumulator for fluid energy storage. The pressurized fluid is then directed to a high-speed hydraulic motor causing it to spin at approximately 1500-1800 RPM. The motor is coupled to a generator for generating appropriately cycled electricity.

U.S. Pat. No. 8,106,527, having the same inventor, discloses and claims a hydraulic drive-train for driving wind and water turbines. The generating system is placed in a water or wind current, and the rotor blades on the system are rotated by the kinetic energy in the moving water or wind currents generating rotational mechanical energy. The rotors are functionally connected to a rotor shaft causing it to rotate which in turn powers a hydraulic pump creating a hydraulic pressure. The hydraulic pressure is directed to a hydraulic motor which is coupled to an electrical generator. The hydraulic generator motor converts the pressurized flow back to rotational energy which spins the generator generating electricity for delivery to the grid. The depressurized fluid is directed to a reservoir to be recycled to the hydraulic pump for another cycle. In prior art systems a mechanical step-up gear drive-train directly couples the rotors to the generator requiring the two be in close proximity to each other, and further the gears allow vibrations to be transferred between the rotors and generator. The hydrostatic system eliminates the mechanical gears which allow the rotors and generator to be distantly located, and it eliminates the vibration torque between the rotors and the generator. The 527 document is incorporated as a disclosure reference. The present disclosure includes elements not disclosed and claimed in the 527 document including the use of a hydraulic accumulator for storing fluid energy for later use.

Hydraulic accumulators are pressure storage reservoirs in which a non-compressible hydraulic fluid is maintained under pressure by an external force such as a compressed gas, a raised weigh, or a loaded spring. These energy storage devices also allow a hydraulic system to smooth out pulsations resulting from the pumping motion, and to respond quickly to a temporary demand. Examples of hydraulic accumulators include towers, compressed gas, raised weights, springs, and metal bellows.

Compressed gas accumulators may be open or closed systems. A compressed gas closed accumulator consists of a cylinder with two clambers separate by an elastic diagram, a bladder, or a piston. One of the clambers contains hydraulic fluid which is connected to a hydraulic line, the other chamber contains an inert gas as nitrogen which provides a compressive force. Some systems are associated with bottled gas for further storage. A compressed gas open accumulator works by drawing air from the atmosphere where it is expelled back into, that is, decompressed air is not stored. A hydraulic pump maintains the pressure balance of air by increasing the amount of hydraulic fluid in the system resulting in a steady state pressure of air which can be up to 25 times the energy density of a standard hydraulic system.

Raised weight accumulators include vertical cylinders containing fluid as water connected to hydraulic line being separated by a piston. The weight causes a downward force on the piston. These type systems deliver a nearly constant pressure regardless of the level of the fluid inside. With the spring systems a series of springs are used to provide compressive forces which behave according to Hooke's Law.

In the present disclosure, a hydraulic accumulator is coupled to a high pressure manifold to store fluid energy for later use and to decouple the pulsations in the flow from the hydraulic pump to the input flow to the hydraulic motor.

Tidal current velocity follows a sinusoidal time history curve passing though each ebb or flood current peak between slack waters. As previously discussed, tidal charts list daily times for slack waters and peak flows at thousands of location around the world. A plot of current speed in meters/second virus time in hours yields a sin curve from zero velocity at slack water rising to peak current velocity (occurring at about 3 hours in semi-diurnal between low and high tide) thereafter falling back to slack water for an about 6 hour tidal cycle where there are 4 cycles per day with a few minutes over. Current velocity at any given time during a cycle (Vₜ) equals Peak Velocity (Vₘₐₓ) times sin(pi)t/period of oscillation (T).

As previously discussed, the power density is directly proportional to the cube of the current velocity, thus, the power density can be calculated for any time during the cycle. At and around slack water the power density is zero or close to. Therefore, there are four time periods during a daily cycle in which there is no electrical production from tidal current turbines, these periods are predictable by the tidal charts. It follows highest production is during peak current flow.

It would be desirable to harness the energy during periods of high flow, store the energy, and thereafter use the energy for electrical generation during periods of low or no flow. In the present disclosure, a water and wind turbine drive-train is formed from a low-speed hydraulic pump which is driven by a rotor powered by the kinetic energy in the aforementioned moving currents. The hydraulic pump pumps hydraulic fluid into a high-pressure manifold to which a hydraulic accumulator is coupled to store the fluid energy. The hydraulic fluid is there after transferred to a high-speed hydraulic motor converting the hydraulic pressure back to rotational torque which spins an attached generator generating electricity. The depressurized fluid from the hydraulic motor is returned to a reservoir to be used in another cycle. The hydraulic accumulator allows the fluid energy to be temporally stored for later use.

Several rotor designs are presently used on wind and tidal turbines. Since wind turbines preceded tidal systems by several years, the wind turbine designs have been tested in water turbines. Over the years these designs have experienced several problems including marine species injury, seaweed detention, and tip vortex. U.S. Pat. Nos. 7,736,127 and 8,100,648, having the same inventor, disclose and claim an improved tidal rotor design for tidal generators. As indicated above, patent document US2012-0114483 having the same inventor discloses and claims a MPCC which controls the direction and pitch of the rotor blade in accordance to the tidal charts. The 127, 648, and 0114483 documents are incorporated as essential disclosure references in the present application.

Hydraulic systems are presently used in yaw mechanisms to control the orientation of wind turbines according to wind direction and to control the rotor pitch according to wind speed. U.S. Pat. No. 6,327,957 discloses a downwind wind turbine having flexible, pitch changeable rotor blades; U.S. Pat. No. 7,911,074 discloses a method for controlling a wind turbine connected to the grid by detecting the status of the grid and thereafter controlling the blades; and U.S. Pat. No. 7,938,622 discloses a tapered helical device auger turbine to convert hydrokinetic energy to electrical energy.

The above references fall to at least teach or suggest the design of the presently disclosed and claimed invention.

### BRIEF SUMMARY OF THE INVENTION

The present invention relates to an electrical power generating system, and methods thereof, for generating electricity from a kinetic energy fuel source as moving water or wind. The generating system is positioned parallel to the fuel source, and rotor blades convert the kinetic energy into mechanical energy. The mechanical energy is transferred to a low-speed hydraulic pump through a rotor shaft, where the pump is driven at rotor speed converting the mechanical energy into hydraulic (fluid) energy which is pumped into a high pressure manifold. The high pressure manifold is coupled to a hydraulic accumulator for storing the fluid energy. The fluid energy is transferred to a high-speed hydraulic motor which converts the fluid energy into mechanical rotation energy which spins a generator coupled to the hydraulic motor. The depressurized fluid is collected in a reservoir to be recycled to the pump. In one embodiment of the present invention, the fluid energy from wind turbines is stored in hydraulic accumulators during periods of high water current velocity to associated tidal turbines, where the stored fluid energy is then used to power the generator during periods of slow water current velocity to the tidal turbines. A computer algorithm based on the tidal charts controls a flow value for coordinating the release of stored fluid energy, generated from wind turbines, during periods of slow water current velocity. This has a net effect of evening out electrical production to the grid rather than the cyclical pattern as when tidal currents are used alone.

Accordingly, the primary objective of this invention is to produce electricity with an electrical generator system which uses kinetic energy from wind and water currents as the fuel source where rotors convert the kinetic energy into mechanical energy.

A further objective of the invention is to convert the mechanical energy into fluid energy with a hydraulic drive-train formed from a hydraulic pump, a high pressure manifold, a hydraulic accumulator, and a hydraulic motor coupled to an electrical generator.

A further objective of the invention is to include a hydraulic accumulator to store the fluid energy in the accumulator until needed.

A further objective of the invention is to utilize tidal turbines and wind turbines at the same generating site where the fluid energy generated by the wind turbine is stored in a hydraulic accumulator and then used during periods of slow current velocity to associated tidal turbines.

### BRIEF DESCRIPTION OF THE DRAWINGS

Other features of the present invention will become evident from a consideration of the following patent drawings which form a part of the specification.

FIG. 1 is a schematic side view of the present generating system having a wind turbine and a tidal turbine, both with hydrostatic drive-trains for generating, storing, and delivering fluid energy to a hydraulic motor coupled to generator.

FIG. 2 is a schematic of the circuit for controlling the hydraulic drive-train in a turbine where the drive-train includes a hydraulic accumulator for storing fluid energy.

FIG. 3 is a schematic of the circuit for controlling the hydraulic drive-train in a turbine where the drive-train does not include an accumulator.

FIG. 4 is a chart of a tidal cycle occurring in a semi-diurnal tide from a first slack tide until a second slack tide showing a plot of current velocity virus time.

FIG. 5 is a cut-away schematic of the hydraulic dive-train located ground-level in a control building.

FIG. 6 is a flow chart for the computer commands which control the valve allowing flow of pressurized hydraulic fluid from the high pressure manifold with hydraulic accumulator to the hydraulic motor according to the tidal charts.

### DETAILED DESCRIPTION OF THE INVENTION

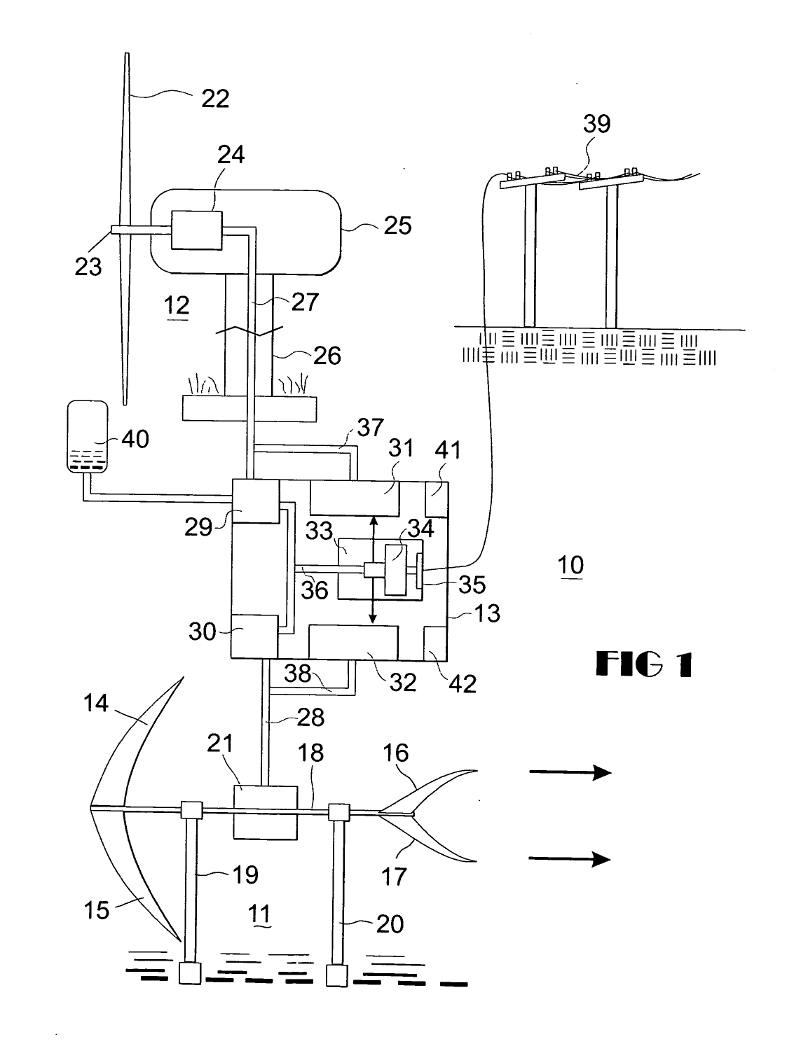

Referring now to the drawings, and first to FIG. 1, there is shown a schematic side view of a generating site, generally designated 10, which includes at least one tidal turbine 11 and at least one wind turbine 12. Both the tidal turbine 11 and the wind turbine 12 have hydraulic drive-trains for converting the kinetic energy of the water currents and of the wind currents into hydraulic (fluid) energy. The fluid energy from both systems is directed to a hydraulic fluid control system housed in enclosure 13 where the fluid energy is converted back into mechanical rotational energy for spinning a coupled generator generating electricity for input into the grid 39. The term at least one indicates that in the schematic at least one wind turbine and at least one tidal turbine are used in combination at the site, but there may be more than one wind system and more than one tidal system in the combination. During operation, a plurality of wind turbines (12) and a plurality of tidal turbines (11) are operating at the site associated with each other.

The tidal system 11 is positioned and maintained in a water current by support columns 19,20 anchored in the seabed, the water currents are moving from left to right. Other methods known in the art can also be used to anchor the system. A rotor shaft 18 is functionally connected to the support columns 19,20, and two rotor blades 14,15 are pivotally connected to a front end of the rotor shaft 18 and two other blades 16,17 are pivotally connected to a rear end of the rotor shaft 18. The rotor blades in the illustration are disclosed and claimed in U.S. Pat. Nos. 7,736,127 and 8,100,648, and microprocessor method for controlling their direction and pitch according to the tidal charts is disclosed and claimed in US2012-0114483. The disclosure is for illustration and not intended to restrict, many designs of rotor blades can be used on the tidal generating systems 11. In general, rotor blades convert the kinetic energy in the fuel source into mechanical energy thereby creating torque; the above constitute a rotor means.

The kinetic energy in the flowing water causes the rotor shaft 18 to rotate turning the hydraulic pump 21 generating a hydraulic pressure. The hydraulic pump 21 is a low-speed pump driven at rotor speed. The fluid energy from the hydraulic pump 21 is directed to a high-pressure manifold 30 through pipe connection 28. The fluid energy is thereafter directed through another pipe connection 36 to a hydraulic motor 33 which converts the fluid energy back into mechanical rotational energy which spins synchronous generator 34 generating electricity for the grid 39. The electricity is conditioned for the grid 39 by a power conditioner 35. The hydraulic motor 33 is a high-speed motor driven at around 1500 to 1800 RPM. The depressurized fluid is returned from hydraulic motor 33 to a low pressure reservoir 32 to be recycled to pump 21 through pipe connection 38 and pipe connection 28 which includes an outflow and an inflow pipe to the hydraulic pump 21.

Referring to the top of FIG. 1, there is shown a schematic side view of a wind turbine generally designated 12. The rotor 22 of the wind turbine 12 harnesses the kinetic energy in the wind currents converting it into mechanical energy which is transferred to a hydraulic pump 24 though a rotor shaft 23. A hydraulic pump 24 converts the mechanical energy into fluid energy which is transferred to a high pressure manifold 29 through pipe arrangement 27. The hydraulic pump 24 is located in a nacelle 25 mounted on top of a support tower 26 which may reach many stories in the air. The hydraulic pump 24 is a slow-speed pump turned at rotor speed creating fluid energy which is directed to a high pressure manifold 29 in a building 13 through pipe assembly 27.

The high pressure manifold 29 associated with the wind turbine 12 is coupled to a hydraulic accumulator 40. Hydraulic accumulators are fluid energy storage devices having pressure storage reservoirs in which a non-compressible hydraulic fluid is maintained under pressure by an external force such as a compressed gas, a raised weight, or a loaded spring. Examples include compressed gas as nitrogen, towers filled with water, raised weights, springs under tension, and metal bellows. In the present disclosure, hydraulic accumulators are coupled to a high pressure manifolds to store fluid energy for later use. Also, they decouple the pulsations in the outflow from the hydraulic pump 24 to the input flow to the hydraulic motor 33. Hydraulic accumulators are temporary storage devices used to respond quickly to an energy demand.

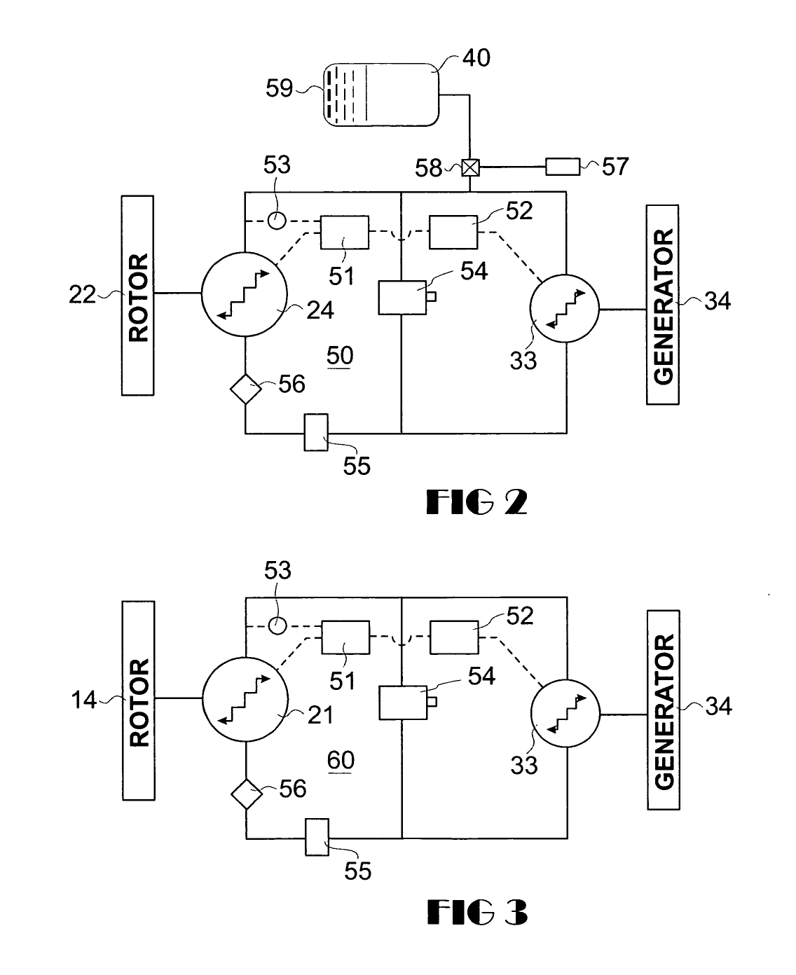

The fluid energy in the high pressure manifold 29, and when appropriate the fluid energy in the accumulator 40, is directed to the hydraulic motor 33 through pipe connector 36. The hydraulic motor 33 converts the fluid energy into rotational mechanical energy for generating electricity. The depressurized fluid from motor 33 is returned to reservoir 31 to be recycled to turbine 12 through pipe 37 and pipe assembly 27 for another cycle. Turbine control circuit 41 controls the wind turbine 12, and turbine control circuit 42 controls the tidal turbine 11. These circuits are shown in FIG. 2 and discussed below.

Referring now to FIG. 2, there is shown a schematic view of the turbine control circuit, generally designated 50, used to control wind turbine 12. As discussed above, the hydrostatic transmission is formed from a low-speed hydraulic pump 24 which is driven at rotor speed and pumps hydraulic fluid into a high pressure manifold 29 coupled to a hydraulic accumulator 40. The fluid energy is then used to drive a high speed hydraulic motor 33 at around 1500 to 1800 RPM. The hydraulic motor 33 is functionally connected to a generator 34 causing it to spin thereby generating electricity for delivery to the grid.

In the illustration, the accumulator 40 is a closed gas system in which nitrogen is compressed in a gas clamber 59. A non-compressible hydraulic fluid is in the other clamber where the two are separated by a bellow. The illustration is not intended to apply any restrictions, other types of accumulators including a raised weight, a loaded spring, and an open-gas system can be used in the present invention; these constitute a hydraulic accumulator means. A brake 57 controls the flow of hydraulic fluid into and out off the accumulator 40 through a brake value 58.

The control circuit further includes a pump controller 51 which controls the low-speed hydraulic pump 24, and a pressure transducer 53 which monitors the line pressure for input into the pump controller 51. A second pump controller 52 controls the high-speed hydraulic motor 33 causing it to turn at around 1500 to 1800 RPM. Energy lost in the system causes heat which is dissipated by a cooler 55 into the atmosphere. The fluid is filtered by a filter 56 before returning to the hydraulic pump 24. There is a relief value 54 between the high pressure line and the low pressure line for emergency relief.

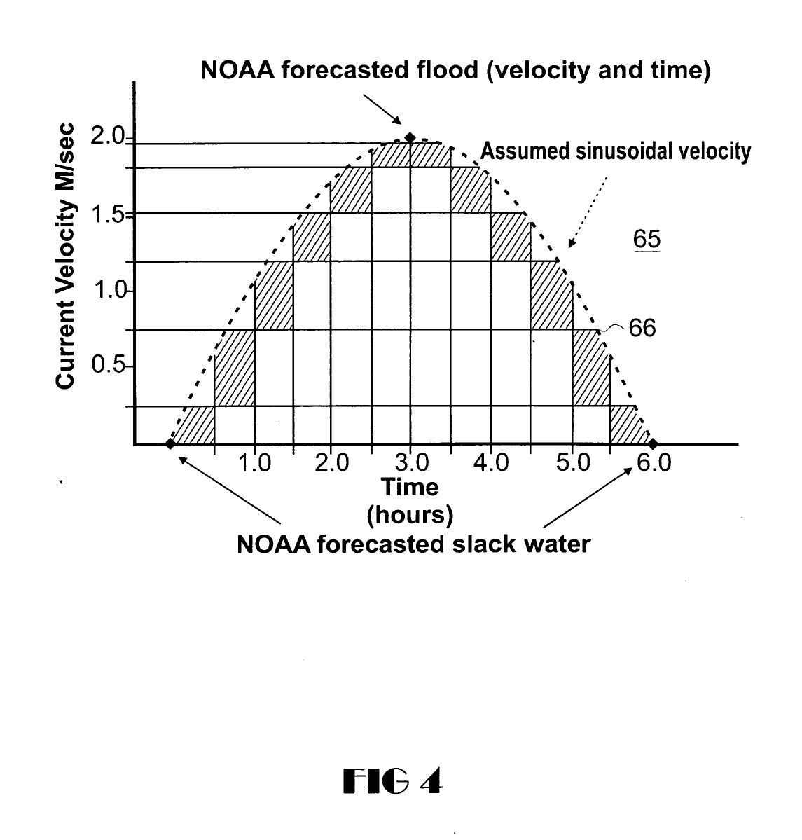

Referring now to FIG. 3, there is shown a schematic control circuit for a system with no hydraulic accumulator. Rotor 14 drives the low-speed hydraulic pump 21 which generates fluid energy to drive the high-speed hydraulic motor 33. Pump controller 51 controls the low-speed pump 21 and transducer 53 monitors the pressure in the high pressure line. Pump controller 52 controls the high-speed hydraulic motor 33. Cooler 55, filter 56, and relief value 54 perform similar functions as discussed above.

Referring back to FIG. 1, it can be seen in the illustration that a hydraulic accumulator 40 is coupled to the high pressure manifold 29 which is associated with the wind turbine 12. There is no accumulator coupled the high pressure manifold 30 associated with the tidal turbine 11. This is for illustrative purposes only, and not intended to be restrictive; an accumulator could also be coupled to the high pressure manifold 30 which is associated with the tidal turbine 12.

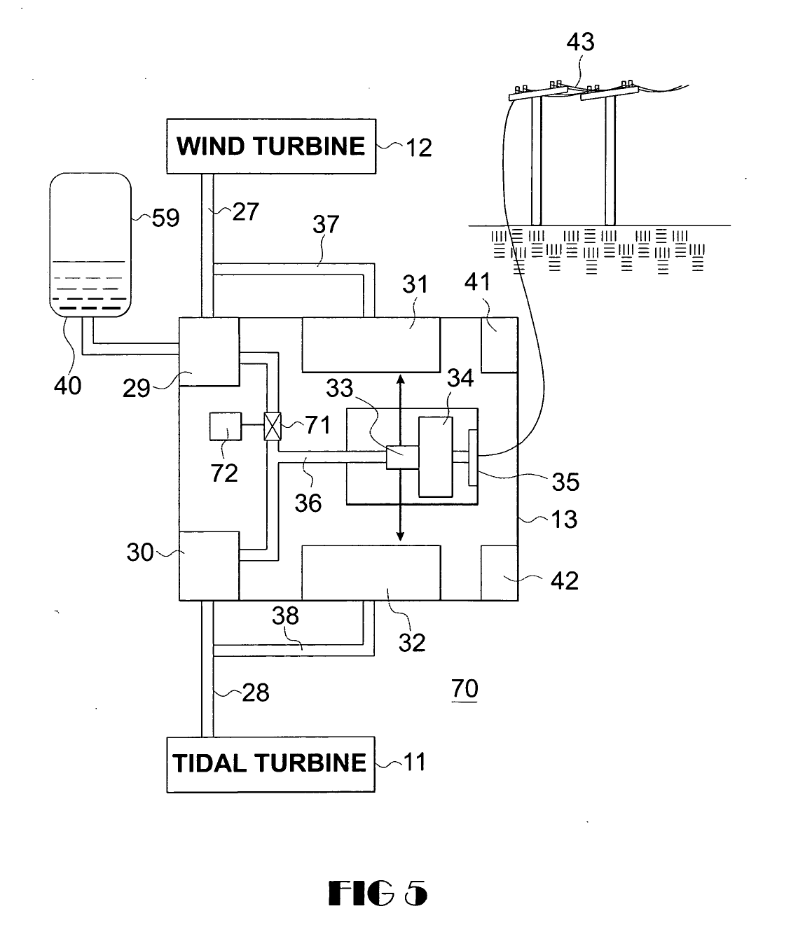

Referring now to FIG. 4, there is shown a plot of a semi-diurnal tidal current pattern, generally designated 65. Tidal current velocity follows a sinusoidal time curve passing through each ebb and flood current peak between slack waters. Tidal current tables list daily times for slack water and peak flows for thousands of locations throughout the world. A plot of current velocity in meters/second virus time in hours yields a sin curve from zero velocity at a first slack water rising to peak current (occurring at around three hours midway between high/low tide) thereafter falling back to a second slack water for a nearly 6 hour tidal cycle. There are 4 nearly alike cycles occurring in just a little over 24 hours, one cycle is shown in the plot. The other three cycles would be similar with slight variations in peak velocity.

As discussed in a previous section, mathematically there is a formula for determining current velocity at any given time during the cycle. The present plot illustrates a time history for 30 minute average velocities during the cycle from slack back to slack. As an example, the time period for the hours of 5 to 5.5 in the cycle, designated 66, would have an average current velocity of about 0.75 m/sec as seen on the Y axis. Average power density for a thirty minute time period can be calculated by inserting mean current velocity in the power density equation.

From the chart in FIG. 4 it can be seen that tidal generators produce electricity in cycles, and the time and amount of production is predictable from the tidal charts. This predictability is a very desirable feature for utility companies who most often purchase the electricity in determining production schedules for input into the grid. Wind turbines also produce electricity in cycles but their production is not predictable since wind currents are intermittent, predictable only minutes in advance.

The inclusion of hydraulic accumulators in the hydrostatic drive-train of tidal and wind turbines for storing energy can provide several advantages. In wind turbines, the fluid energy generated during stronger currents can be stored for use during weaker currents, or the total fluid energy over a time period can be stored for later use providing a predictable electrical input into the grid. With tidal systems, fluid energy generated during higher current velocities can be stored for use during slower current velocities. In another example, the fluid energy generated by the wind turbine could be stored and used to compliment production by associated tidal systems during time periods of low current velocity. At and around slack water there are periods of no electrical production, these periods are predictable from the tidal charts. Wind turbines depend on intermittent wind currents and are unpredictable. In the following embodiment, fluid energy generated by the wind turbines is stored in hydraulic accumulators and later used during time periods of low current velocity to compliment production in associated tidal systems. This combination would produce a more steady flow of electricity into the grid rather than the cyclical input as shown in FIG. 4.

Referring now to FIG. 5, there is shown a cut-away schematic side view of a hydraulic control center, generally designated 70, housed in enclosure 13. Wind turbine 12 delivers fluid energy to the high pressure manifold 29 through pipe 27. A high-pressure manifold 29 is coupled to a hydraulic accumulator 40 where fluid energy is stored for later use. Tidal turbine 11 delivers fluid energy to high pressure manifold 30. In the illustration, fluid energy from both manifolds 29,30 are directed to the hydraulic motor 33 where the fluid energy is converted into rotational mechanical energy for spinning the generator 34 producing electricity for the grid 39. Power conditioner 35 conditions the electricity for the grid 39. Since the hydraulic motor 33 turns at around 1500 to 1800 RPM, the electricity is at or near grid cycles. The depressurized fluid from hydraulic motor 33 is directed to reservoir 31 for return to the turbine 12 through pipe 37 to an input pipe located in pipe assembly 27. Likewise, depressurized fluid from hydraulic motor 30 is directed to reservoir 32 for return to turbine 11 through pipe 38. The reservoirs 31,32 may be open (atmospheric) or closed (pressurized) as commonly used in other industries.

In the illustration, wind turbine 12 and tidal turbine 11 feed the same hydraulic motor 33. The present illustration is not intended to be restrictive. The system can be designed where several hydraulic pumps feed a multi-pump connection which feeds a hydraulic motor. The high pressure manifold functions as multi-pump connection where several pumps feed hydraulic pressure into it. As an example, between one and thirty hydraulic pumps 33 could be connected to the high-pressure manifold 29 or to high pressure manifold 30 forming a multi-pump connection, this constitutes a multi-pump connection means. In most field operations, several hydraulic pumps, from both tidal and wind units, feed high pressure multi-pump collection manifolds for powering the hydraulic motor.

In one embodiment, the fluid energy created from the wind turbines is temporary stored in the accumulator, and then used to feed the generator during periods of low current velocity to associated tidal turbines. As previously discussed, electrical production from tidal systems is cyclical as a result of low water flow at and around slack tides; these periods are predictable from tidal charts. To even out production, the hydraulic motor/generator is powered by stored fluid pressure from wind turbines during these periods of low current velocity. A MPCC is used to release the stored fluid energy during these periods of low water current velocity; the MPCC is programmed with the area's tidal chart information which forms a valve release schedule. The valve control board 72 and the control valve 71 can be seen in FIG. 5. As an example, the valve 71 is opened during periods of low tidal current velocity releasing stored fluid energy to maintain electricity production. This constitutes a valve release means.

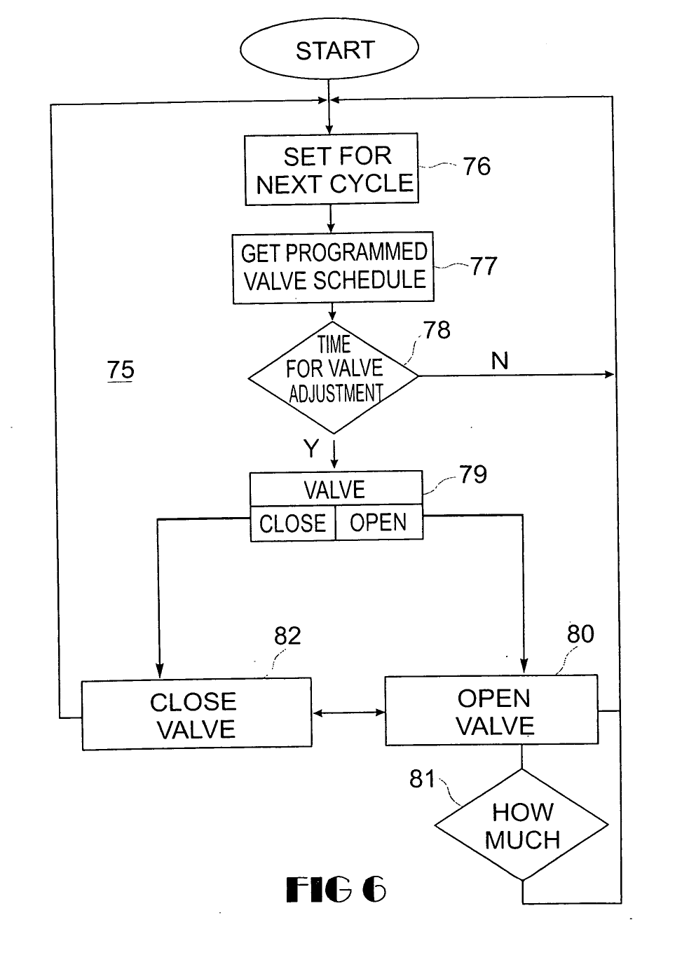

Referring now to FIG. 6, there is shown a flow chart, generally designated 75, illustrating how the commands are processed by a MPCC 72 for controlling a control valve 71. The control valve 71 controls the flow of pressurized fluid from the hydraulic accumulator 40 into pipe 36 which feeds hydraulic motor 33. Valve schedule data, based on the tidal charts, is down-loaded and stored in the MPCC for opening and closing the valve 71. A subroutine can further control the amount of hydraulic fluid flowing through the valve 71. In block 76, the MP resets for another cycle. In block 77, the MPCC retrieves the stored valve schedule, that is, the times the valve is scheduled to be opened and closed according to the tidal chart. In decision block 78, the MPCC determines if it is time for a valve 71 adjustment. A negative decision in block 78 causes an exit from the loop wherein it resets for another cycle. A positive decision in block 78 causes the MPCC to enter block 79 whereby the valve is opened, or causes the MPCC to enter block 82 whereby the valve is closed. The amount of pressurized fluid allowed to flow through valve 71 can be controlled by pressure regulators or it can be controlled by decision block 81 which determines the degree to which the valve is opened. The greater the degree of opening, the greater the flow rate which is based on the tidal charts.

The power density of a flowing current is directly proportional to the cube of the current speed. During a tidal cycle, current velocity goes from zero at a first slack water to maximum at peak velocity, and back to zero at a second slack. Conventional hydraulic machines with older designs have good machine efficiencies at full displacement (higher RPM) and poor efficiencies at partial displacement (lower RPM). This has been a disadvantage over the years when a cyclical fuel source as water or wind currents are used. These loses in efficiencies have historically limited hydraulic machines in several applications possibly including their use in wind turbines.

Recent developments have designed more efficient hydraulic machines for converting mechanical energy to fluid energy at partial displacement. An example is the variable displacement pump where displacement, the amount of fluid pumped per revolution of the pump input shaft, can be varied while the pump is running. Examples of variable displacement pumps include the axial piston pump and the bent axis piston pump. These pumps typically have several pistons in cylinders arranged parallel to each other which rotate around a central shaft. A swash plate is connected to the pistons at one end. As the pistons rotate the angle of the plate causes them to move in and then out of a cylinder, and a rotary value at the other end alternately connects each cylinder to the fluid supply and the delivery lines. The stroke of the piston can be varied by changing the angle of the swash plate. When there is a sharp angle, a large volume is pumped; when the swash plate is perpendicular to the axis of rotation, no fluid is pumped. More complex variable displacement pumps use digital technology which employs communicating ports to switch the clambers between high and low pressure manifolds. These pumps work by using a continuously varying ratio of disabled to enabled cylinders. Most variable displacement pumps are reversible, they can act also as hydraulic motors which covert fluid energy back into mechanical energy. In the present disclosure, the hydraulic pump means includes the older designs as well as the newer variable displacement systems.

The present invention may, of course, be carried out in ways other than those herein set forth without parting from the spirit and essential characteristics of the invention. The present embodiment are therefore to be considered in all respects as illustrative and not restrictive, and all changes coming within the meaning and equivalency range of the appended claims are intended to be embraced therein.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

18. (canceled)

19. (canceled)

20. (canceled)

21. (canceled)

22. (canceled)

23. (canceled)

24. (canceled)

25. A method for storing fluid energy in a hydraulic accumulator and later releasing said fluid energy using a microprocessor means for controlling a release valve means, comprising the steps of: a. downloading to a storage device in said microprocessor means a valve schedule for opening and closing said release valve means based on the tidal charts; b. determining if it is time for a valve adjustment; c. opening said release valve means at scheduled time; or d. closing said release valve means at scheduled time.

26. The method as recited in claim 25, wherein step c further comprises the step of determining a degree to open or close said release valve based on the tidal charts.

27. (canceled)

28. (canceled)

29. (canceled)

30. An electrical power generating plant which includes: at least one tidal turbine means having a first rotor means for converting the kinetic energy in a water current into mechanical energy which is transferred through a first rotor shaft to a first hydrostatic drive-train which includes a first hydraulic pump means for converting said mechanical energy into tidal generated fluid energy which is transferred to a first high pressure manifold means and then piped to a hydraulic motor means for converting said tidal generated fluid energy into rotational mechanical energy which spins a generator means coupled to said hydraulic motor means, where said tidal turbine is used in combination with at least one wind turbine having a second rotor means for converting the kinetic energy in a wind current into mechanical energy which is transferred through a second rotor shaft to a second hydrostatic drive-train which includes a second hydraulic pump means for converting said mechanical energy into wind generated fluid energy which is transferred to a second high pressure manifold means which is coupled to a hydraulic accumulator means for storing said wind generated fluid energy which is later piped to said hydraulic motor means for converting said wind generated fluid energy into rotational mechanical energy which spins a generator means coupled to said hydraulic motor means, wherein said electrical power generating system includes: a valve control means for causing said wind generated fluid energy to be directed from said second high pressure manifold means to said hydraulic motor during a period of time corresponding to a slower current velocity of a tidal cycle, and to be directed to said hydraulic accumulator during a period of time corresponding to a higher current velocity whereby said wind generated fluid energy is temporary stored during said period of time corresponding to said higher current velocity and used to power said generator during said period of time corresponding to slower current velocity.

31. (canceled)

32. (canceled)

33. (canceled)

34. (canceled)

35. (canceled)

36. An electrical power generating system including a generator means for generating electricity, comprising: at least one tidal turbine means for harvesting kinetic energy from a water current having a first hydraulic pump means for generating and delivering tidal generated fluid energy to a first high pressure manifold means functionally connected to a hydraulic motor means for converting said tidal generated fluid energy into rotational mechanical energy which causes said generator means to spin; at least one wind turbine means for harvesting kinetic energy in a wind current having a second hydraulic pump means for generating and delivering to a second high pressure manifold means for storing wind generated fluid energy where said second high pressure manifold means is functionally connected to a hydraulic accumulator means for temporary storing said wind generated fluid energy where said second high pressure manifold is further functionally connected to said hydraulic motor means, where time and rate of said wind generated fluid energy from said second high pressure manifold means and from said hydraulic accumulator means to said hydraulic motor means is controlled by a microprocessor control center means configured to: receive and store in a memory means a valve release schedule means which includes a look-up table means which corresponds to predicted times taken from a tidal table which list predicted times for slack tide and magnitude of tidal current velocity during a tidal cycle whereby said look-up table includes data points which cause a control valve means to be closed during a period of time corresponding to higher current velocity and to be open during a period of time corresponding to lower current velocity; determine if it is time for a control valve adjustment; and instruct said valve release means to either close or to open said control valve means whereby said tidal generated fluid energy flows to said hydraulic accumulator during said period of times corresponding to higher current velocity and to said hydraulic motor during said periods of time corresponding to slower current velocity.

37. A computer for controlling the operation of an electrical power generating system having at least one tidal turbine means including a first hydraulic drive train means which includes a first high pressure manifold means for collecting tidal generated fluid energy functionally connected to a hydraulic motor means, and having at least one wind turbine means having a second hydraulic drive train means which includes a second high pressure manifold means for collecting and storing wind generated fluid energy, where said second high pressure manifold is functionally connected to a hydraulic accumulator for temporary storing said wind generated fluid energy and further to said hydraulic motor means, wherein flow of said wind generated fluid energy from said second high pressure manifold means and said hydraulic accumulator means to said hydraulic accumulator means is controlled by a valve release means controlled by a computer comprising: a down-load communication means for receiving a programmed valve release schedule means which includes a look-up table with assigned times for a valve control means to be open and to be closed corresponding to predicted times taken from a tidal chart, where said valve release schedule means is stored in a memory means, and a processor having an input pathway to receive an input signal including said programmed valve release schedule; determine if it is time for a control valve adjustment; and an output pathway for output signals causing said control valve to be either opened or closed.

38. A computer program for controlling the operation an electrical power generating system having at least one tidal turbine means including a first hydraulic drive train means which includes a first high pressure manifold means for collecting tidal generated fluid energy functionally connected to a hydraulic motor means, and having at least one wind turbine means having a second hydraulic drive train means which includes a second high pressure manifold means for collecting and storing wind generated fluid energy, where said second high pressure manifold means is functionally connected to a hydraulic accumulator means for temporary storing said wind generated fluid energy and further to said hydraulic motor means, wherein flow of said wind generated fluid energy from said second high pressure manifold means and said hydraulic accumulator means to said hydraulic motor is controlled by a computer including at least one processor and memory storage device, said computer program comprising: code instructing said at least one processor to accept input signals indicative of a programmed valve release schedule means; code instructing said at least one processor to process said input signal to determine if it is time for a valve adjustment; and code instructing said at least one processor to send output signals to cause a valve release means to either open or close a control valve means.
